(19) United States
(12) Patent Application Publication
(10) Pub. No.: US 2020/0348146 A1
(43) Pub. Date: Nov. 5, 2020

(54) APPARATUS FOR GENERATING DATA OF TRAVEL PATH INSIDE INTERSECTION, PROGRAM FOR GENERATING DATA OF TRAVEL PATH INSIDE INTERSECTION, AND STORAGE MEDIUM

(71) Applicant: DENSO CORPORATION, Kariya-city (JP)

(72) Inventors: Minoru YOKOTA, Kariya-city (JP); Shigehiro MUTO, Kariya-city (JP)

(21) Appl. No.: 16/929,331

(22) Filed: Jul. 15, 2020

Related U.S. Application Data
(63) Continuation of application No. PCT/JP2018/040335, filed on Oct. 30, 2018.

(30) Foreign Application Priority Data
Jan. 18, 2018 (JP) 2018-006429

(51) Int. Cl. G01C 21/36; G05D 1/00; B60W 50/00

(52) U.S. Cl. CPC G01C 21/3658; G05D 1/0088; G05D 2201/0213; B60W 2552/53; B60W 50/0097

(57) ABSTRACT

A travel path data generation apparatus for generating data of a travel path inside an intersection for automated driving is provided. The travel path data generation apparatus determines a fitting target exit lane of lane network data from among a plurality of exit lanes of the lane network data that are set for one enter lane of the lane network data. The travel path data generation apparatus fits an estimated trajectory of actual vehicle traveling inside the intersection to the fitting target exit lane of the lane network data by using an absolute trajectory of the actual vehicle traveling inside the intersection.

### CROSS-REFERENCE TO RELATED APPLICATIONS

This application is a continuation application of PCT/JP2018/040335 filed on Oct. 30, 2018, which designated the U.S and claims the benefit of priority from Japanese application No. 2018-006429 filed on Jan. 18, 2018. The entire disclosures of all of the above applications are incorporated herein by reference.

### TECHNICAL FIELD

The present disclosure relates to an apparatus for generating data of a travel path inside in intersection, a program for generating data of a travel path inside in intersection, and a storage medium.

### BACKGROUND

There is a method of highly accurately measuring shapes and positions of roads by dedicated vehicles, and generating travel path data for automated driving. This method in principle requires a huge amount of work by expensive sensors and man powers, and can generate the travel path data only in a limited area such as a highway and a motorway. It is therefore not possible to generate travel path data for local roads and the like, and it is not possible to generate travel path data for an intersection.

### SUMMARY

The present disclosure provides a travel path data generation apparatus for generating data of a travel path inside an intersection for automated driving. The travel path data generation apparatus determines a fitting target exit lane of lane network data from among a plurality of exit lanes of the lane network data that are set for one enter lane of the lane network data. The travel path data generation apparatus fits an estimated trajectory of actual vehicle traveling inside the intersection to the fitting target exit lane of the lane network data by using an absolute trajectory of the actual vehicle traveling inside the intersection.

### BRIEF DESCRIPTION OF DRAWINGS

Objects, features and advantages of the present disclosure will become more apparent from the following detailed description made with reference to the accompanying drawings. In the drawings:

FIG. 1 is a functional block diagram illustrating an overall configuration of a first embodiment;

FIG. 2 is a diagram illustrating generation of travel path data;

FIG. 3 is a diagram illustrating selection of correct travel path data;

FIG. 4 is a functional block diagram of a travel path data generator;

FIG. 5 is a flowchart illustrating a travel path data generation process;

FIG. 6 is a diagram illustrating aggregation of curvature change lines;

FIG. 7 is a diagram illustrating arrangement and alignment of a plurality of curvature change lines;

FIG. 8 is a diagram illustrating division of a plurality of curvature change lines into groups,

FIG. 9 is a diagram illustrating fitting of an estimated trajectory to a left exit lane of lane network data;

FIG. 10 is a diagram illustrating fitting of an estimated trajectory to a right exit lane of lane network data;

FIG. 11 is a diagram illustrating division of a plurality of curvature change lines into groups;

FIG. 12 is a functional block diagram of a travel path data generator of a second embodiment;

FIG. 13 is a flowchart illustrating a travel path data generation process;

FIG. 14 is a diagram illustrating specifying a start point;

FIG. 15 is a diagram illustrating specifying an exit reference straight line;

FIG. 16 is a diagram illustrating calculation of a normal line distance;

FIG. 17 is a diagram illustrating a normal line distance equal to or larger than a threshold; and

FIG. 18 is a diagram illustrating a normal line distance less than a threshold.

### DETAILED DESCRIPTION

It is desired to establish a technology for generating data of travel paths inside intersections.

For example, there is a first method of estimating a new road from a GPS trajectory showing GPS (Global Positioning System) positions of a vehicle, estimating a connection between the estimated new road and an existing road, and updating map data. In addition, there is a second method of generating data of a travel path inside an intersection by connecting an exit lane and an enter lane by an arc (quadratic Bezier curve), wherein the enter lane is a lane from which the intersection is entered and the exit lane is a lane to which an intersection is exited.

The first method has such a problem that the GPS positions are widely scattered and the travel path data generated by the first method is inferior in accuracy. In the second method, since actual vehicle travel paths inside intersections vary depending on shapes of the intersections, it is highly likely that the generated travel path data may deviate from the actual travel paths and may not be practical. For addressing these problems, a conceivable method for generating data of a travel path inside an intersection may include fitting an estimated trajectory of actual vehicle traveling inside the intersection into lane network data connected to the intersection by using an absolute trajectory of the actual vehicle traveling inside the intersection.

At an intersection where a plurality of exit lanes are constructed for one enter lane, the plurality of exit lanes of lane network data may be set for the one enter lane of the lane network data. Therefore, when attempting to generate data of a travel path inside this kind of intersection by using the above-way, it is necessary determine, from among the plurality of exit lanes of the lane network data, an exit lane of the lane network data to which the estimated trajectory is fitted.

It is an object of the present disclosure to provide an apparatus for an apparatus for generating data of a travel path inside in intersection, a program for generating data of a travel path inside in intersection, and a storage medium that can appropriately generate data of a travel path inside an intersection for automated driving even in cases where a plurality of exit lanes are constructed for one enter lane for the intersection.

In an aspect of the present disclosure, a fitting target determination unit determines a fitting target exit lane of lane network data from among a plurality of exit lanes of the lane network data that are set for one enter lane of the lane network data. A fitting unit fits an estimated trajectory of actual vehicle traveling inside the intersection to the fitting target exit lane of the lane network data by using an absolute trajectory of the actual vehicle traveling inside the intersection.

In cases where a plurality of exit lanes of the lane network data are set for one enter lane of the lane network data, a fitting target exit lane of the lane network data is determined from among the plurality of exit lanes of the lane network data. This makes it possible to appropriately generate data of a travel path inside an intersection for automated driving even in cases where a plurality of exit lanes are constructed for one enter lane for the intersection.

### First Embodiment

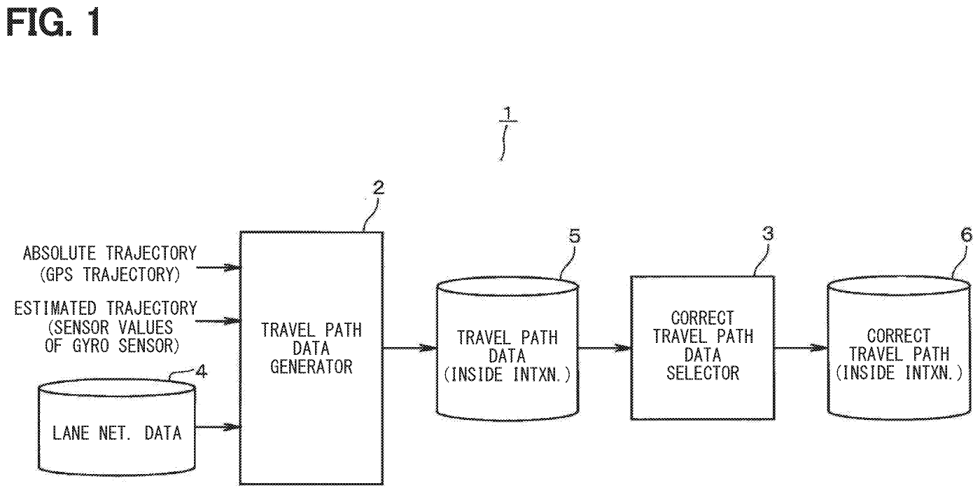

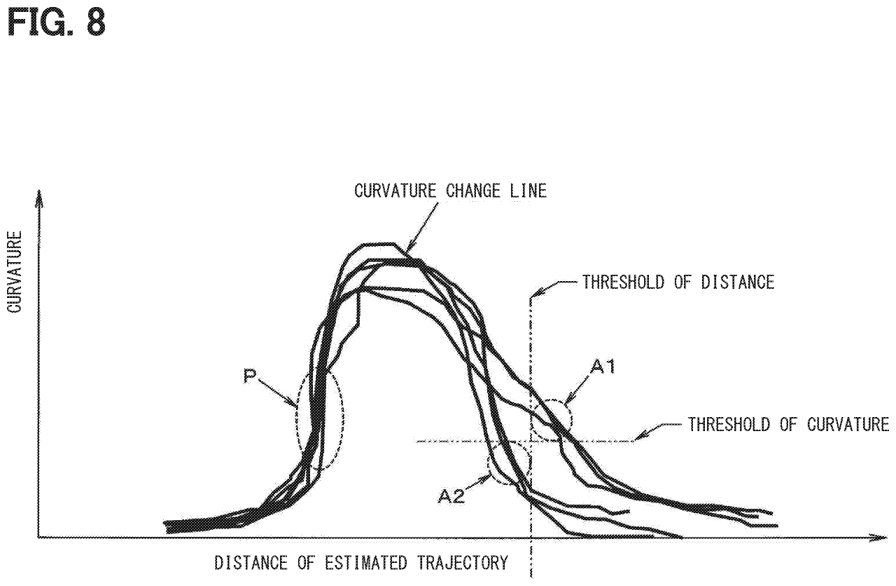

Hereinafter, a first embodiment will be described with reference to FIGS. 1 to 11. An inside-intersection-travel-path data generation apparatus 1 is for generating data of travel paths inside intersections for automated driving, and includes a travel path data generator 2 and a correct travel path data selector 3, as illustrated in FIG. 1.

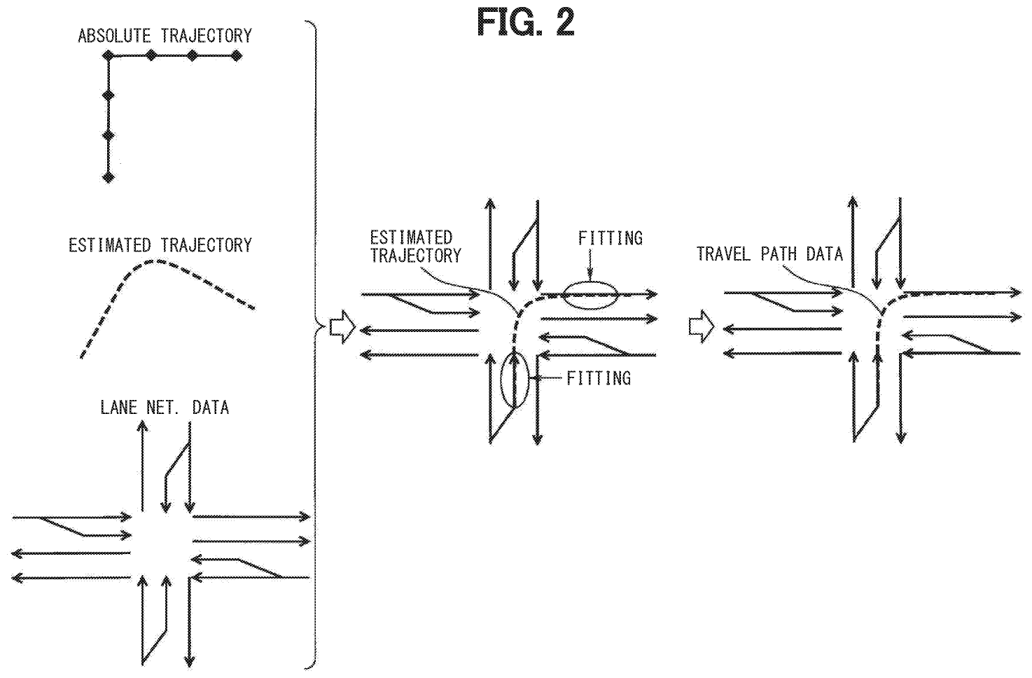

As illustrated in FIG. 2, the travel path data generator 2 has inputs of absolute trajectories and estimated trajectories from vehicles, also has inputs of lane network data stored in a lane network data storage 4, fits the estimated trajectories to the lane network data by using the absolute trajectories, and generate the data of travel paths inside intersections. The absolute trajectory is a trajectory of a vehicle at a time when the vehicle actually traveled inside the intersection, and the absolute trajectory is, for example, a GPS trajectory given by GPS positions. The estimated trajectory is a trajectory of the vehicle at the time of actual traveling of the vehicle inside the intersection, and the estimated trajectory is for example a trajectory given by sensor values of a gyro sensor. The lane network data is data of travel paths outside intersections. When the travel path data generator 2 generates the data of a travel path inside an intersection, the travel path data generator 2 outputs the generated data of the travel path inside the intersection to a travel path data storage 5 to store the data of the travel path data inside the intersection in the travel path data storage 5.

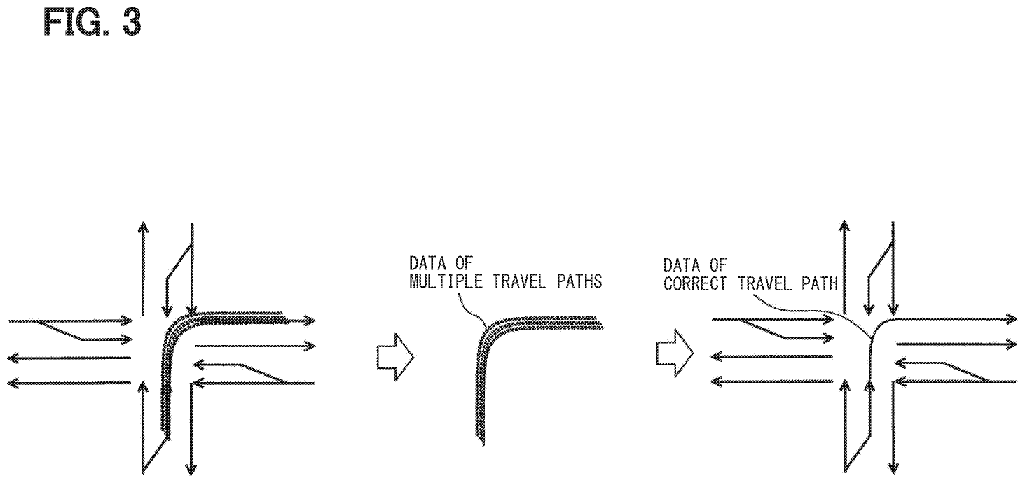

As illustrated in FIG. 3, the correct travel path data selector 3 has inputs of the data of a plurality of travel paths inside an intersection stored in the travel path data storage 5, and selects the data of a correct travel path from the data of the plurality of travel paths. Then, the correct travel path data selector 3 outputs the data of the selected correct travel path to a correct travel path data storage 6 to store the data of the correct travel path data in the correct travel path data storage 6.

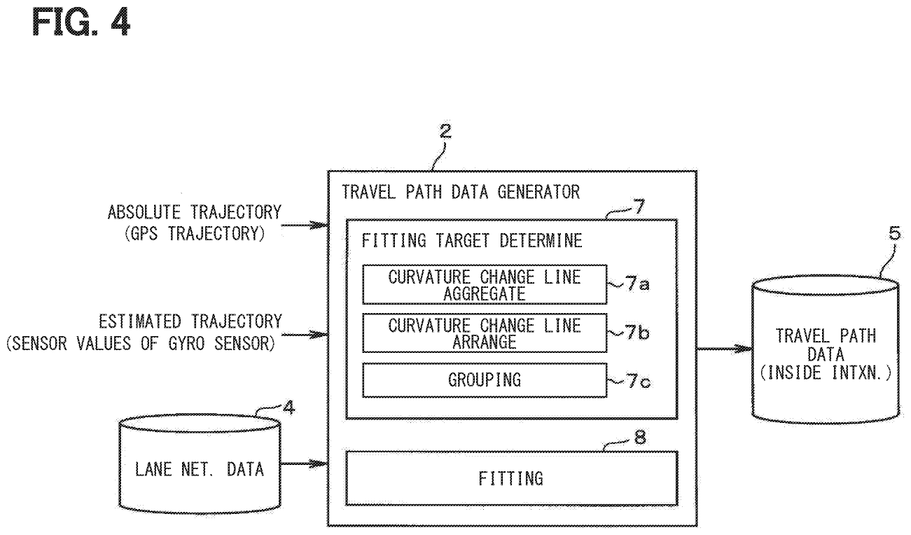

As illustrated in FIG. 4, the travel path data generator 2 includes a fitting target determination unit 7 and a fitting unit 8. The fitting target determination unit 7 includes a curvature change line aggregation unit 7a, a curvature change line arrangement unit 7b, and a grouping unit 7c. These functional blocks are implemented by a microcomputer comprising a CPU (Central Processing Unit), a ROM (Read Only Memory), a RAM (Random Access Memory), and an I/O (Input/Output). The microcomputer executes computer programs stored in a non-transitory tangible storage medium to execute processing corresponding to the computer programs, and controls an overall operation of the travel path data generation apparatus 1. The computer programs executed by the microcomputer include a travel path data generation program.

The curvature change line aggregation unit 7a aggregates curvature change lines each representing a changes in curvature of an estimated trajectory over the distance of the estimated trajectory. The curvature change line arrangement unit 7b arranges the plurality of curvature change lines aggregated by the curvature change line aggregation unit 7a such that the plurality of curvature change lines are aligned at a predetermined distance by using a predetermined curvature as a criteria. The grouping unit 7c divides the plurality of curvature change lines arranged by the curvature change line arrangement unit 7b into groups according to degree of the change at an exit-side portion. The fitting target determination unit 7 determines a fitting target exit lane of the lane network data according the groups grouped by the grouping unit 7c.

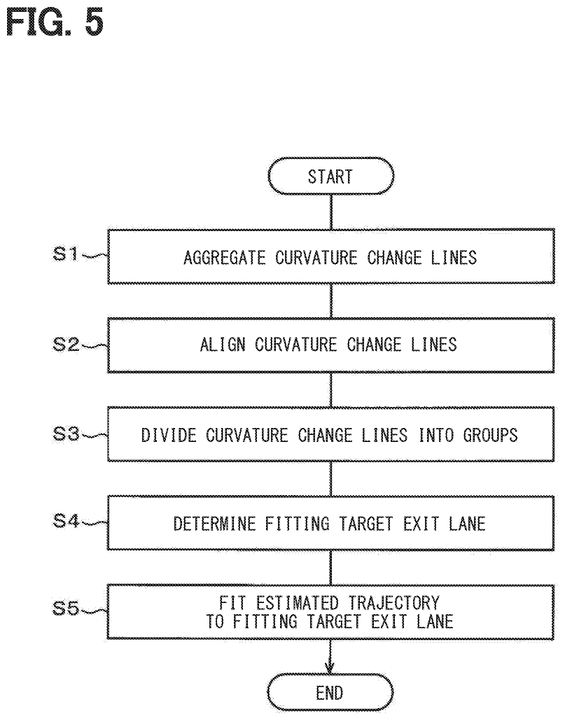

Next, operation of the above configuration will be described with reference to FIGS. 5 to 11. In the travel path data generation apparatus 1, the travel path data generator 2 executes the travel path data generation program to execute the travel path data generation process. Now, explanation will be given on cases where, with regard to lanes for a vehicle to make a right turn at an intersection, a plurality of exit lanes are constructed for one enter lane.

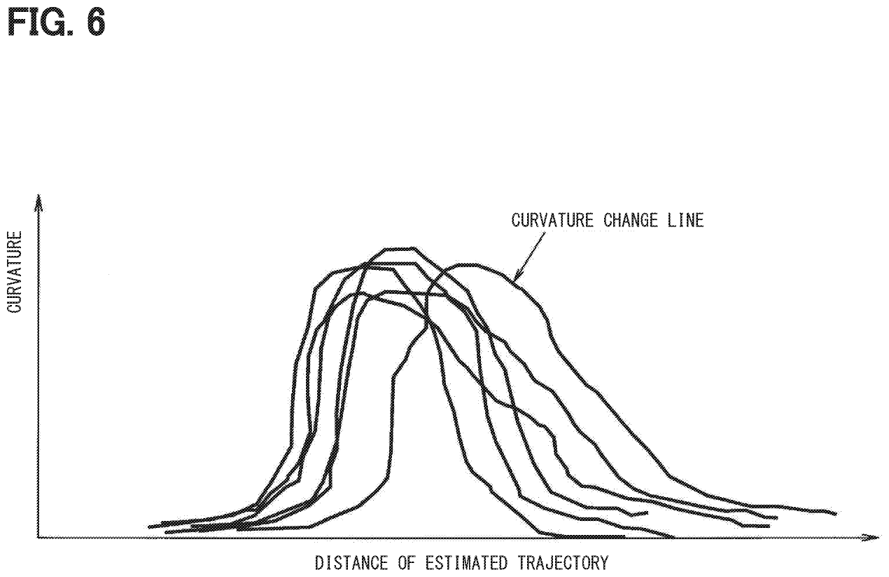

In response to establishment of a start event of the travel path data generation process, the travel path data generator 2 starts the travel path data generation process and aggregates the curvature change lines each representing the change in curvature of an estimated trajectory over distance of the estimated trajectory (S1, corresponding to a curvature change line aggregation procedure). As illustrated in FIG. 6, the travel path data generator 2 specifies a curvature change line for each of the plurality of estimated trajectories, and aggregates the specified curvature change lines of respective estimated trajectories.

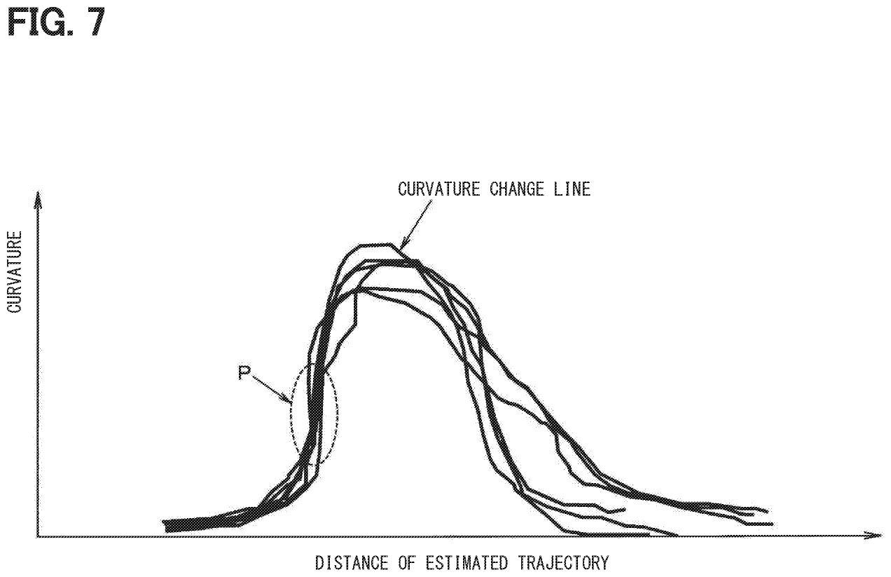

Next, the travel path data generator 2 arranges the plurality of curvature change lines such that intersection-enter-side portions of the plurality of curvature change lines are aligned at the predetermined distance by using the predetermined curvature as the criteria (S2, corresponding to a curvature change line arrangement procedure). As illustrated in FIG. 7, targeting all of the curvature change lines, the travel path data generator 2 translate a respective curvature change line in a direction of the distance of the estimated trajectory so that all of the curvature change lines pass through a region “P” which is at an enter-side portion of the intersection. Specifically, in cases where vehicles make a right turn in traveling through an intersection where a plurality of exit lanes are constructed for one enter lane for the right-turn, there is no great difference in the degree of the change in entering regardless of which exit lane the vehicles exit to. Thus, the travel path data generator 2 arranges the plurality of curvature change lines such that the curvature change lines are aligned at the enter-side portion of the intersection.

Next, the travel path data generator 2 divides the plurality of curvature change lines into groups according to the degree of the change at an exit side portion so the number of group equals the number of exit lanes of the lane network data (S3, corresponding to a grouping procedure). Specifically, in cases where vehicles make a right turn in traveling through intersection where a plurality of exit lanes are constructed for one enter lane for the right-turn, there is a significant difference in the degree of the change in exiting although there is no great difference in the degree of the change in entering regardless of which exit lane the vehicles exit to. Thus, the travel path data generator 2 groups the plurality of curvature change lines on a basis of intersection-exit-side portions of the curvature change lines. In cases where two exit lanes of the lane network are set for one enter lane of the lane network data, the travel path data generator 2 sets one threshold for curvature and one threshold for distance, and divides the plurality of curvature change lines into two groups according to the threshold of the curvature and the threshold of the distance.

Next, the travel path data generator 2 determines a fitting target exit lane of the lane network data according to the groups (S4). The steps S1 to S4 described above correspond to a fitting target determination procedure. With regard to the estimated trajectory corresponding to the curvature change line passing through a region “A1” in which the curvature is larger than the threshold and the distance is lager than the threshold, the travel path data generator 2 determines a left exit lane of the lane network data as the fitting target exit lane of the lane network data of from among the two exit lanes of the lane network data. Specifically, the travel path data generator 2 determines that the estimated trajectory having, at the exit side portion, a relatively small degree of curvature decreasing with increasing distance of the estimated trajectory is the estimated trajectory having a relatively small turning angle, and determines that the left exit lane of the lane network data as the fitting target exit lane of the lane network data.

With regard to the estimated trajectory corresponding to the curvature change line passing through a region “A2” in which the curvature is smaller than the threshold and the distance is smaller than the threshold, the travel path data generator 2 determines a right exit lane of the lane network data as the fitting target exit lane of the lane network data from among the lane network data of the two exit lanes. Specifically, the travel path data generator 2 determines that the estimated trajectory having, at the exit side portion, a relatively large degree of curvature decrease with increasing distance of the estimated trajectory is the estimated trajectory having a relatively large turning angle, and determines that the right exit lane of the lane network data as the fitting target exit lane of the lane network data. In the above, by the travel path data generator 2, the post-grouping curvature change lines not passing through any of the regions is excluded from subject to determine the fitting target exit lane of the lane network data.

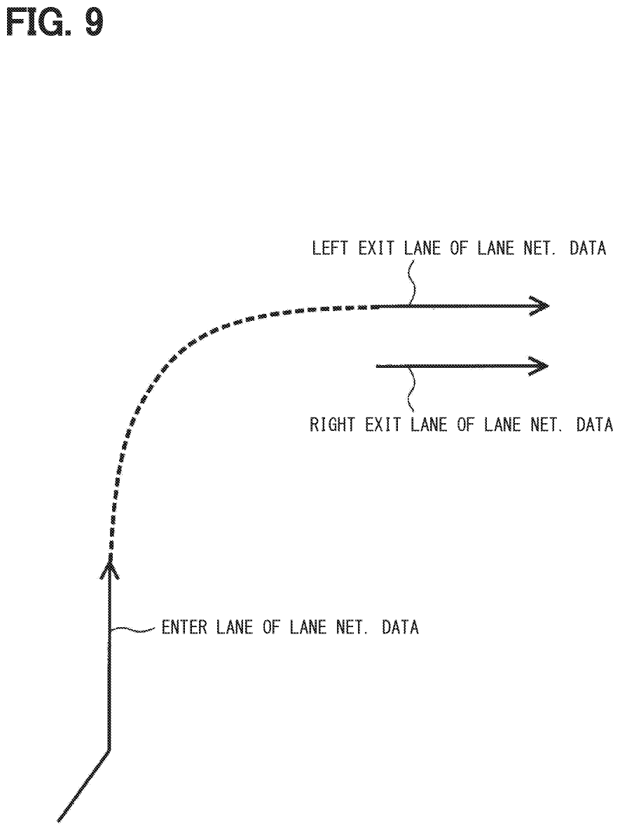

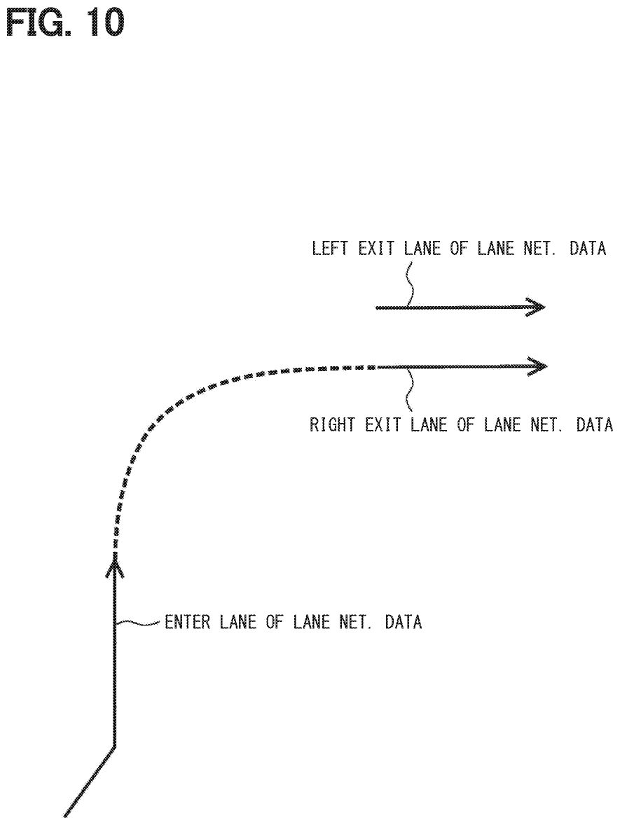

Then, the travel path data generator 2 fits the estimated trajectory to the determined fitting target exit lane of the lane network data by using the absolute trajectory and subsequently fits the estimated trajectory to the exit lane of the lane network data, so that the data of the travel path inside the intersection is generated (S5, corresponding to a fitting procedure). As illustrated in FIG. 9, in cases where the travel path data generator 2 determines the left exit lane of the lane network data as the fitting target exit lane of the lane network data from among the two exit lanes of the lane network data, the travel path data generator 2 fits the estimated trajectory to the left exit lane of the lane network data to generate the data of the travel path inside the intersection. As illustrated in FIG. 10, in cases where the travel path data generator 2 determines the right exit lane of the lane network data as the fitting target exit lane of the lane network data from among the two exit lanes of the lane network data, the travel path data generator 2 fits the estimated trajectory to the right exit lane of the lane network data to generate the data of the travel path inside the intersection.

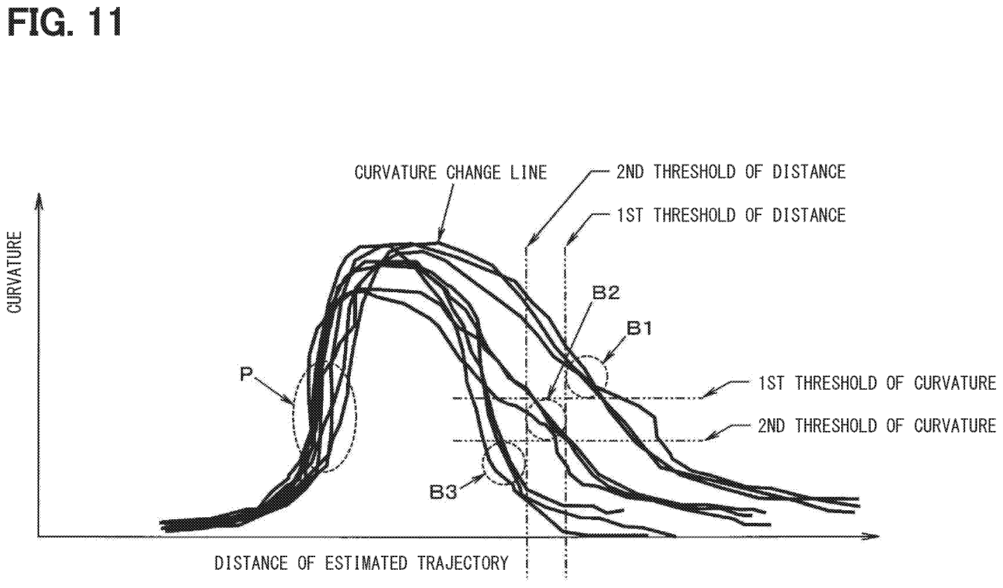

The above illustrates cases where the two exit lanes of the lane network data are set for one enter lane of the lane network data, the same applies to cases where three or more exit lanes of the lane network data are set for one enter lane of the lane network data. As illustrated in FIG. 11, in cases where three exit lanes of the lane network data are set for one enter lane of the lane network data, the travel path data generator 2 sets two thresholds for the curvature and two thresholds for the distance, groups the plurality of curvature change lines according to the two thresholds of the curvature and the two thresholds of the distance, and determines a fitting target exit lane of the lane network data from among the three exit lanes of the lane network data.

Specifically, with regard to the estimated trajectory corresponding to the curvature change line passing through a region “B1” in which the curvature is large than a first threshold and the distance is larger than a first threshold, the travel path data generator 2 determines a left exit lane of the lane network data as the fitting target exit lane of the lane network data from among the three exit lanes of the lane network data. With regard to the estimated trajectory corresponding to the curvature change line passing through a region “B2” in which the curvature is between the first threshold and a second threshold and the distance is between the first threshold and a second threshold, the travel path data generator 2 determines a center exit lane of the lane network data as the fitting target exit lane of the lane network data from among the three exit lanes of the lane network data. With regard to the estimated trajectory corresponding to the curvature change line passing through a region “B3” due to having the curvature smaller than the second threshold and having the distance smaller than the second threshold, the travel path data generator 2 determines the lane network data of a right exit lane as the lane network data of the fitting target exit lane from among the lane network data of the three exit lanes.

The first embodiment as described above provides the below effects. In cases where a plurality of exit lanes of the lane network data are set for one enter lane of the lane network data, a fitting target exit lane of the lane network data is determined from among the plurality of exit lanes of the lane network data, and the estimated trajectory is fitted to he fitting target exit lane of the lane network data. As a result, in an intersection where a plurality of exit lanes of the lane network data are set for one enter lane of the lane network data, it is possible to appropriately fit the estimated trajectory to the fitting target exit lane of the lane network data, and it is possible to appropriately generate the data of the travel path inside the intersection for automated driving.

In addition, the fitting target exit lane of the lane network data is determined via performing the determination using the curvature change line showing the change in the curvature of the estimated trajectory over the distance of the estimated trajectory. By determining the curvature change line, it is possible to appropriately determine the fitting target exit lane of the lane network data.

Although the above illustrates cases where a plurality of exit lanes are constructed for one enter lane with regard to lanes for vehicles to make a right turn at an intersection, the same applies to cases where a plurality of exit lanes are constructed for one enter lane with regard to lanes for vehicles to make a left turn at an intersection. Specifically, even for cases where vehicles make a left turn at an intersection, a fitting target exit lane of the lane network data is determined from among a plurality of exit lanes of the lane network data via performing the curvature change line, and the estimated trajectory is fitted to the fitting target exit lane of the lane network data appropriately.

### Second Embodiment

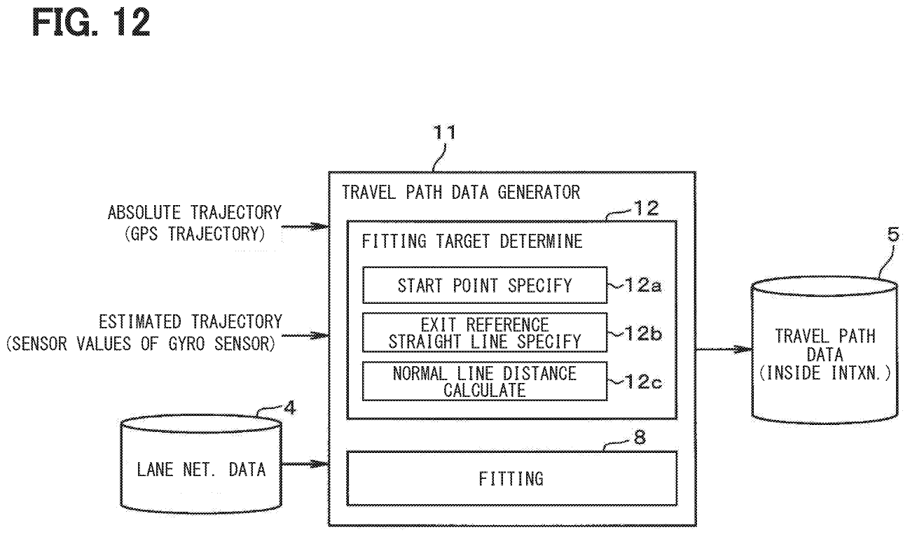

Next, a second embodiment will be described with reference to FIGS. 12 to 18. Description of the same portions as those in the first embodiment will be omitted, and differences from the first embodiment will be described. The second embodiment is different from the first embodiment in a manner of determining a fitting target lane of the lane network data.

As illustrated in FIG. 4, a travel path data generator 11 includes a fitting target determination unit 12 and a fitting unit 8. The fitting target determination unit 12 includes a start point specifying unit 12a, an exit reference straight line specifying unit 12b, and a normal line distance calculation unit 12c. These functional blocks are also implemented by a microcomputer comprising a CPU, ROM, RAM and I/O.

The start point specifying unit 12a specifies, among the enter-side portion of the estimated trajectory, a start point which is a point where the curvature reaches a first predetermined value. The exit reference straight line specifying unit 12b specifies an exit reference straight line which is a straight line that is parallel to the exit lanes of the lane network data and that passes through a point of the exit side portion of the estimated trajectory where the curvature reaches a second predetermined value. The normal line distance calculation unit 12c calculates a normal line distance between the start point and the exit reference straight line. The fitting target determination unit 12 determines a fitting target exit lane of the lane network data according to the normal line distance calculated by the normal line distance calculation unit 12c.

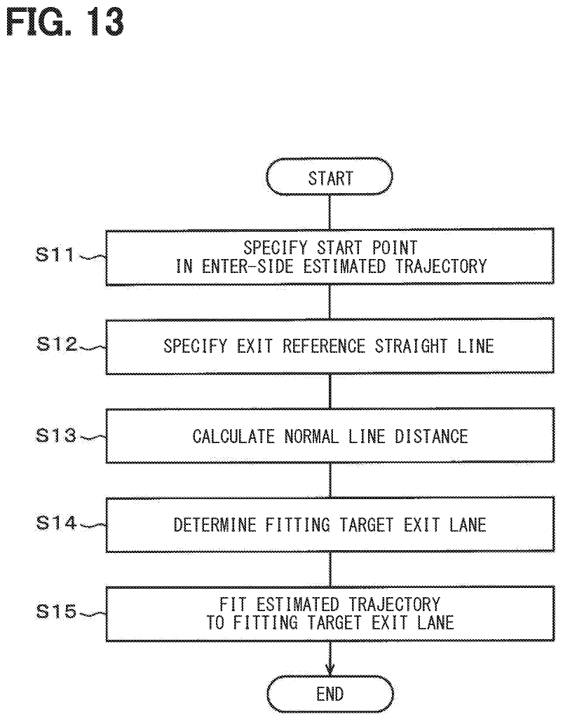

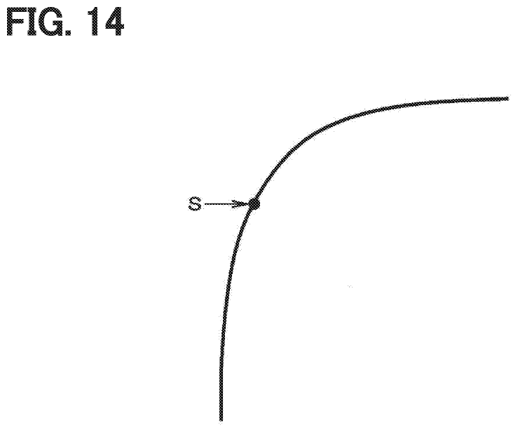

Next, operation of the above configuration will be described with reference to FIGS. 13 to 18. In response to establishment of a start event of the travel path data generation process, the travel path data generator 11 starts the travel path data generation process and specifies, from among an enter side portion of the estimated trajectory, a start point being a point where the curvature reaches the first predetermined value (S11, corresponding to a start point specifying procedure). As illustrated in FIG. 14, the travel path data generator 11 specifies the point where the curvature reaches the first predetermined value as the start point “S”. The first predetermined value is a value that makes it distinguishable the vehicle starting the right turn, and the predetermined value is distant from “0”.

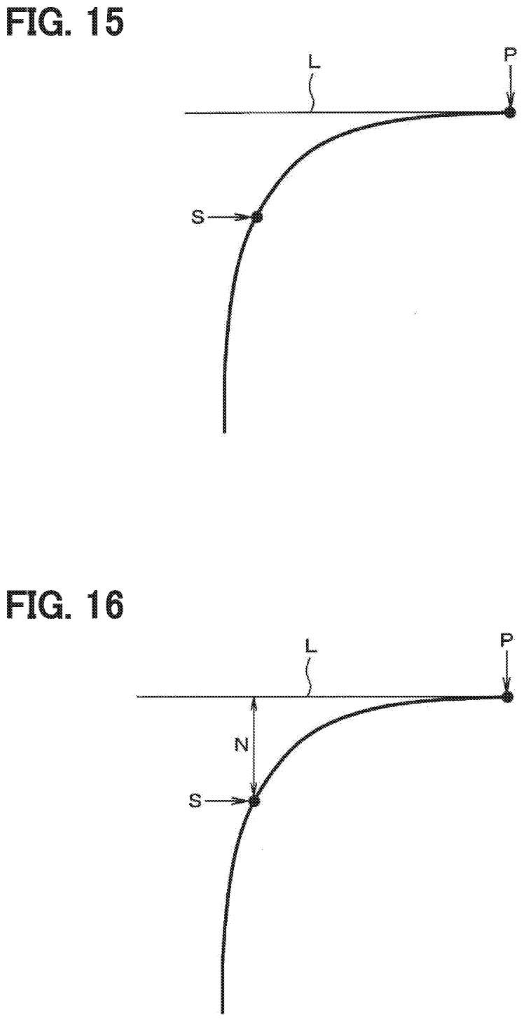

Next, the travel path data generator 11 specifies the exit reference straight line being a straight line that is parallel to the exit lanes of the lane network data and that passes through a point of the exit side portion of the estimated trajectory at which the curvature reaches the second predetermined value (S12, corresponding to an exit reference straight line identification procedure). As illustrated in FIG. 15, the straight line parallel to the exit lanes of the lane network data and passing through a point “P” at which the curvature reaches the second predetermined value is specified as the exit reference straight line “L” by the exit the travel path data generator 11. The second predetermined value is a value that makes it distinguishable the vehicle ending the right turn, and the second predetermined value is close to “0”.

Next, the travel path data generator 11 calculates the normal line distance between the start point and the exit reference straight line (S13, corresponding to a normal line distance calculation procedure). As illustrated in FIG. 16, the travel path data generator 11 calculates the normal line distance “N” between the start point “S” and the exit reference straight line “L”.

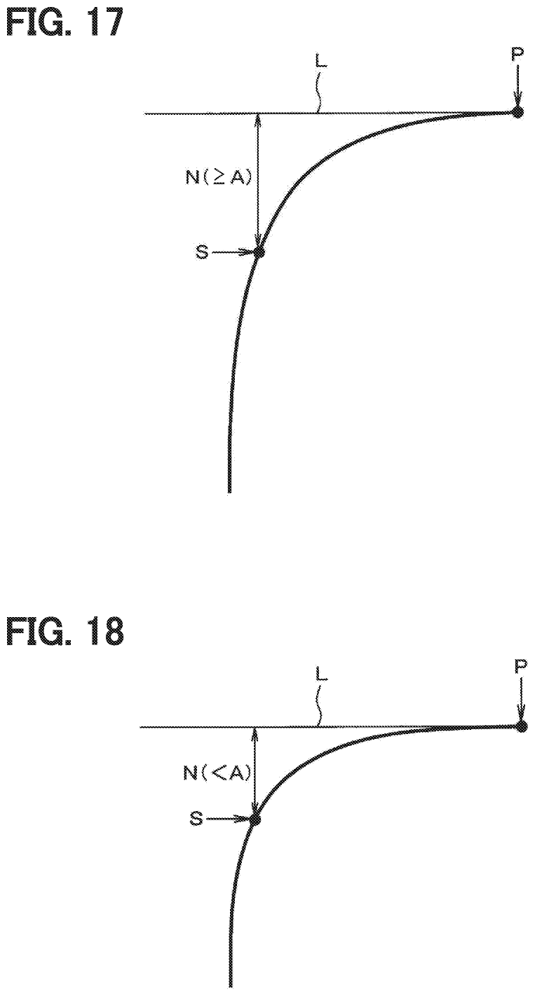

Next, the travel path data generator 11 determines the fitting target exit lane of the lane network data according to the calculated normal line distance (S14). The steps S11 to S14 described above correspond to a fitting target determination procedure. As illustrated in FIG. 17, from among the two exit lanes of the lane network data, the travel path data generator 11 determines the left exit lane of the lane network data as the fitting target exit lane of the lane network data for the estimated trajectory having the normal line distance “N” greater than or equal to a threshold “A”. As illustrated in FIG. 18, from among the two exit lanes of the lane network data, the travel path data generator 11 determines the right exit lane of the lane network data as the fitting target exit lane of the lane network data for the estimated trajectory having the normal line distance “N” less than the threshold “A”.

Thereafter, as in the first embodiment, the travel path data generator 11 fits the estimated trajectory to the fitting target exit lane of the lane network data by using the absolute trajectory, and subsequently fits the estimated trajectory to the enter lane of the lane network data to generate the data of the travel path inside the intersection (S15, corresponding to a fitting procedure).

This also illustrates cases where two exit lanes of the lane network data are set for one enter lane of the lane network data, and the same applies to cases where three or more exit lanes are set for one enter lane in the lane network data. Specifically, in cases where three exit lanes of the lane network data are set for one enter lane of the lane network data, the travel path data generator 11 sets two thresholds and compares the normal line distance with the two thresholds to determine the fitting target exit lane of the lane network data from among the three exit lanes of the lane network data.

The second embodiment as described above can provide the same operational effects as the first embodiment. In addition, the fitting target exit lane of the lane network data is determined via calculating the normal line distance and comparing it with the threshold. By calculating the normal line distance and comparing it with the threshold, it is possible to appropriately determine the fitting target exit lane of the lane network data.

### Other Embodiments

Although the present disclosure has been described with reference to embodiments, it is to be understood that the disclosure is not limited to the embodiments and structures. The present disclosure encompasses various variations and modifications within an equivalent range. In addition, various combinations and forms, and other combinations and forms, including only a single element, more, or less elements, are also within the spirit and scope of the present disclosure.

The manner of the first embodiment and the manner of the second embodiment may be used together. Specifically, when a result of performing the determination using the curvature change line per the first embodiment and a result of performing the determination using the normal line distance match each other, the fitting target exit lane of the lane network data may be determined.

What is claimed is:

1. A travel path data generation apparatus for generating data of a travel path inside an intersection for automated driving, the apparatus comprising:
a fitting target determination unit that, from among a plurality of exit lanes of lane network data that are set for one enter lane of the lane network data, determines a fitting target exit lane of the lane network data; and
a fitting unit that fits an estimated trajectory of actual vehicle traveling inside the intersection to the fitting target exit lane of the lane network data by using an absolute trajectory of the actual vehicle traveling inside the intersection.

2. The travel path data generation apparatus according to claim 1,
wherein the fitting target determination unit includes:
a curvature change line aggregation unit that aggregates curvature change lines each representing a change in curvature of an estimated trajectory over distance of the estimated trajectory;
a curvature change line arrangement section that arranges the curvature change lines by aligning the curvature change lines at a predetermined distance by using a predetermined curvature as a criteria; and
a grouping unit that divides the curvature change lines into groups according to degree of the change at an exit-side portion, wherein the number of groups equals the number of exit lanes of the lane network data,
wherein the fitting target determination unit determines the fitting target exit lane of the lane network data according to the groups.

3. The travel path data generation apparatus according to claim 1,
wherein the fitting target determination unit includes:
a start point specifying unit that specifies, from among an enter-side portion of the estimated trajectory, a start point being a point at which the curvature reaches a first predetermined value;
an exit reference straight line specifying unit that specifies an exit reference straight line being a straight line that is parallel to the exit lanes of the lane network data and that passes through a point of an exit side portion of the estimated trajectory at which the curvature reaches a second predetermined value; and
a normal line distance calculation unit that calculates a normal line distance between the start point and the exit reference straight line,
wherein the fitting target determination unit determines the fitting target exit lane of the lane network data according to the calculated normal line distance.

4. A computer-readable non-transitory storage medium storing a travel path data generation program, the program causing a travel path data generation apparatus to execute:
from among a plurality of exit lanes of lane network data that are set for one enter lane of the lane network data, determining a fitting target exit lane of the lane network data; and
fitting an estimated trajectory of actual vehicle traveling inside the intersection to the fitting target exit lane of the lane network data by using an absolute trajectory of the actual vehicle traveling inside the intersection.

5. The computer-readable non-transitory storage medium storing the travel path data generation program according to claim 4,
determining the fitting target exit lane of the lane network data includes:
aggregating curvature change lines each representing a change in curvature of an estimated trajectory over distance of the estimated trajectory;
arranging the curvature change lines by aligning the curvature change lines at a predetermined distance by using a predetermined curvature as a criteria; and
dividing the curvature change lines into groups according to degree of the change at an exit-side portion, wherein the number of groups equals the number of exit lanes of the lane network data,
wherein the fitting target exit lane of the lane network data is determined according to the groups.

6. The computer-readable non-transitory storage medium storing the travel path data generation program according to claim 4,
wherein determining the fitting target exit lane of the lane network data includes:
specifying, from among an enter-side portion of the estimated trajectory, a start point being a point at which the curvature reaches a first predetermined value;
specifying an exit reference straight line being a straight line that is parallel to the exit lanes of the lane network data and that passes through a point of an exit side portion of the estimated trajectory at which the curvature reaches a second predetermined value; and
calculating a normal line distance between the start point and the exit reference straight line,
wherein the fitting target exit lane of the lane network data is determined according to the calculated normal line distance.

7. A travel path data generation apparatus for generating data of a travel path inside an intersection for automated driving, the apparatus comprising a memory and a processor configured to:
from among a plurality of exit lanes of lane network data that are set for one enter lane of the lane network data, determine a fitting target exit lane of the lane network data; and
fit an estimated trajectory of actual vehicle traveling inside the intersection to the fitting target exit lane of the lane network data by using an absolute trajectory of the actual vehicle traveling inside the intersection.
